(19) United States
(12) Patent Application Publication
(10) Pub. No.: US 2009/0192038 A1
(43) Pub. Date: Jul. 30, 2009

(54) Systems and methods for applying particle films to control stress on plant tissues

(76) Inventors: Ray J. Hoobler, Pleasanton, CA (US); Michael Weber, Sunnyvale, CA (US)

Correspondence Address: CARR & FERRELL LLP, 2200 GENG ROAD, PALO ALTO, CA, 94303, US

(21) Appl. No.: 12/313,192

(22) Filed: Nov. 17, 2008

Related U.S. Application Data
(60) Provisional application No. 61/003,782, filed on Nov. 19, 2007.

(51) Int. Cl. A01N 59/06; B05C 11/00

(52) U.S. Cl. 504/116.1; 118/697

(57) ABSTRACT

Provided herein are systems and methods for applying particle films to control stress on plant tissues. An exemplary method for controlling stress on plant tissues includes calculating a current plant tissue stress value for the plant tissues, and applying an effective amount of a particle film to the plant tissues if the calculated current plant tissue stress value is greater than or equal to a predetermined plant tissue stress value. The method may further include calculating a second current plant tissue stress value for the plant tissues after the application of the effective amount of the particle film, and calculating a future plant tissue stress value for the plant tissues. The calculated current plant tissue stress value, the second current plant tissue stress value, and the future plant tissue stress value may be analyzed to predict a future application of the effective amount of the particle film to the plant tissues.

### CROSS-REFERENCE TO RELATED APPLICATION

This application claims the benefit and priority of U.S. Provisional Patent Application Ser. No. 61/003,782 filed on Nov. 19, 2007 and titled “Using Particle Films to Reduce Stress in Plant Tissue,” which is hereby incorporated by reference.

### BACKGROUND OF THE INVENTION

1. Field of the Invention

This invention relates to protecting plant tissues from stress, and more specifically to systems and methods for applying particle films to control stress on plant tissues.

2. Description of Related Art

Plant tissues may be subjected to various types of stress. For instance, plant tissues may be subjected to transpiration stress. Transpiration is the movement and evaporation of water from various plant tissues, including flowers, fruits, vegetables, stems, leaves, branches and/or roots. Among other things, transpiration is responsible for transporting minerals from the soil throughout a plant, cooling the plant, moving sugars and plant chemicals within the plant, and maintaining turgor pressure of the plant. The amount and rate of transpiration depends on factors such as temperature, humidity, wind, and/or air movement. Transpiration (and thus transpiration stress) is generally greatest in hot, dry (i.e. low relative humidity), windy weather. Symptoms of significant transpiration stress may include reduced transpiration, reduced growth, unhealthy physical appearance, lower yields, and/or plant tissue death. For example, apple trees that are experiencing transpiration stress may produce less apples, smaller apples, and/or lower grades of apples. This may lead to significant financial loss for the grower and/or higher commodity prices for the consumer.

Currently available methods for mitigating transpiration stress on plant tissues, such as increased irrigation, are inefficient, ineffective and/or expensive. For instance, costly increased irrigation may lead to increased soil salinity, which may result in lower crop yields and/or the eventual loss of productive agricultural land. Another method, the use of particle films, may be used to cover plant tissues to reduce sun exposure. The conventional use of overhead irrigation systems, however, prevented the widespread use of particle films due to the washing off/diluting of the particle films. Water conservation efforts, however, have discouraged the use of overhead irrigation systems in favor of direct irrigation systems, such as drip irrigation systems. In such a setting, the use of particle films for reducing sun damage is more feasible. Still, the application of particle films has been haphazard at best, with multiple applications being recommended by the manufacturers of particle films to ensure coverage, without regard to the specific timing of the particle film applications. Consequently, there is a need for systems and methods for applying particle films to control stress on plant tissues.

### SUMMARY OF THE INVENTION

Provided herein are systems and methods for applying particle films to control stress on plant tissues. An exemplary method for controlling stress on plant tissues includes calculating a current plant tissue stress value for the plant tissues, and applying an effective amount of a particle film to the plant tissues if the calculated current plant tissue stress value is greater than or equal to a predetermined plant tissue stress value. The method may further include calculating a second current plant tissue stress value for the plant tissues after the application of the effective amount of the particle film, and calculating a future plant tissue stress value for the plant tissues. The calculated current plant tissue stress value, the second current plant tissue stress value, and the future plant tissue stress value may be analyzed to predict a future application of the effective amount of the particle film to the plant tissues. Additional methods may include irrigating the plant tissues until the calculated second current plant tissue stress value is less than or equal to the predetermined plant tissue stress value.

Exemplary systems for applying particle films to control stress on plant tissues are also provided. Such systems may include a processor, a computer readable storage medium having instructions for execution by the processor which causes the processor to apply the particle film to control stress on the plant tissues, wherein the processor executes the instructions on the computer readable storage medium to calculate a current plant tissue stress value for the plant tissues, and applies an effective amount of a particle film to the plant tissues if the calculated current plant tissue stress value is greater than or equal to a predetermined plant tissue stress value. In a further embodiment, the processor may execute the instructions on the computer readable storage medium to irrigate the plant tissues if the calculated current plant tissue stress value is greater than or equal to the predetermined plant tissue stress value.

### BRIEF DESCRIPTION OF THE DRAWINGS

FIG. 1 is a flow chart of an exemplary method for applying a particle film to control stress on plant tissues;

FIG. 2A is a flow chart of an exemplary predictive method for controlling stress on plant tissues;

FIG. 2B shows an exemplary PCSI UV forecast for the United States; and

FIG. 3 shows an exemplary system for applying particle films to control stress on plant tissues.

### DETAILED DESCRIPTION OF THE INVENTION

Provided herein are exemplary systems and methods for controlling stress on plant tissues. Such embodiments may employ particle films that may include fine mineral particles having an average size of less than two microns, such as specially formulated calcium carbonate compounds in aqueous suspensions. Plant tissues may include the plant tissues of fruit and vegetable crops, row crops, seedlings, nursery stock, trees, flowers, grasses, landscape and ornamental plants. According to various exemplary embodiments, a plant tissue stress value, such as a Crop Water Stress Index (“CWSI”) value, may be calculated and used for determining when to spray a particle film on plant tissues. Plant tissue stress values may be correlated with the application of particle films, so that by monitoring plant tissue stress values, a process for determining optimal application of particle films to plant tissues may be determined. The combined use of transpiration measurements, evapotranspiration data and particle films provide an effective basis for the reduction of stress on plant tissues. When stress on the plant tissues is reduced, yields increase, growth is improved and growing costs are minimized by eliminating unnecessary irrigation and/or unnecessary applications of particle films. Additionally, reduced transpiration stress on the plant tissues may result in greater resistance of the plant tissues to diseases (such as fungal infections by Botrytis), while providing plants with critical nutrients (e.g. calcium).

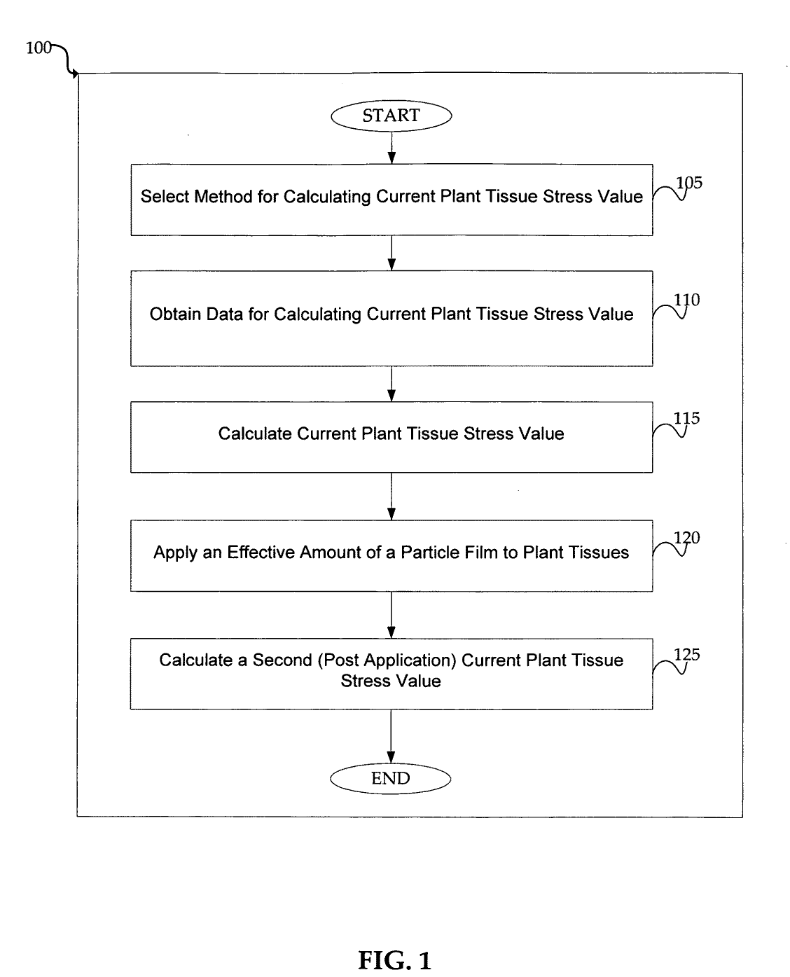

FIG. 1 is a flow chart of an exemplary method 100 for applying a particle film to control stress on plant tissues.

At step 105, a method for calculating current plant tissue stress value is selected. According to various exemplary embodiments, a Crop Water Stress Index may be selected as the method for calculating the current plant tissue stress value. A CWSI value may be calculated and used to determine when to apply a particle film to plant tissues (e.g., when to apply a particle film to a particular crop). Here, the Crop Water Stress Index value may be calculated by the equation:

CWSI=1−ETa/(Kc*ETo)

Referring to the above equation, ETa represents evapotranspiration for the particular crop (i.e. “a” equates to “actual” crop) at a particular point in time. Evapotranspiration is used to describe the sum of evaporation and transpiration from the surface of the earth to the atmosphere. ETa may be a measured parameter based on sap flow for the particular crop. Other methods may be used for determining ETa, such as stem water potential for the particular crop. For instance, ETa values may be measured directly (e.g., pan evaporation). Evaporation accounts for the movement of water from sources such as soil and bodies of water to the atmosphere. Transpiration accounts for the movement and evaporation of water from a plant (or plant tissues) to the atmosphere. Evapotranspiration is typically expressed in millimeters (mm) of water (or millimeters of water per hectare).

Referring again to the above equation, the product Kc*ETo represents maximum transpiration when the particular crop is well-irrigated. ETo represents evapotranspiration for a reference crop. Grass and alfalfa are generally used as reference crops. The reference crops are assumed to be free of water stress and disease, and living in or near the same geographic region as the particular crop undergoing the current plant tissue stress determination. ETo may be determined via the Penman-Monteith method. The Penman-Monteith method takes into account daily mean temperature, wind speed, relative humidity, and solar radiation. ETo is multiplied by Kc, a crop coefficient for the particular crop. Kc may be determined empirically based on historical irrigation data, or determined by other suitable means. Kc varies through the season depending on the growth stage of the particular crop.

According to various exemplary embodiments, the Purfresh™ Crop Stress Index (PCSI) may be selected as a method for calculating the current plant tissue stress value. A PCSI value may be calculated and used to determine when to apply a particle film to plant tissues. The PCSI value is a combined index of air temperature, thermal radiation and UV radiation, weighted for a particular crop. Here, the PCSI value is represented by the equation:

$$PCSI = {C}_{1} ( T - {C}_{2} ) + {C}_{3} {R}_{LW} + {C}_{4} {\sum }_{t = - 30}^{0} {R}_{UV}$$

Referring to the above equation, T is air temperature, R_{LW} is long-wave (thermal/infrared) radiation and R_{UV} is ultraviolet radiation (UV). C₁ through C₄ are coefficients specific to the particular crop and indicate how much the crop is affected by a particular environmental factor. Air temperature and long-wave radiation are measured at their maximum values over a current day. Air temperature usually only impacts a crop over a threshold value as represented by coefficient C₂. The effects of UV radiation are cumulative and therefore this component is summed over the immediately preceding thirty (30) day period.

According to various exemplary embodiments, a Crop Water Stress Index based on canopy-temperature measurements may be selected as a method for calculating the current plant tissue stress value. A CWSI value may be calculated and used to determine when to apply a particle film to plant tissues. Here, the CWSI value is represented by the equation:

CWSI=(T_{c}−Tₘᵢₙ)/Tₘₐₓ−Tₘᵢₙ)

Referring to the above equation, T_{c} is the crop canopy temperature, and Tₘᵢₙ and Tₘₐₓ are the experimental or theoretical minimum and maximum canopy temperatures. As T_{c} approaches Tₘᵢₙ, CWSI approaches 0 (minimal stress); as T_{c} approaches Tₘₐₓ, CWSI approaches 1 (maximum stress).

In yet another embodiment, a solar stress factor (SSF) may be selected as a method for calculating the current plant tissue stress value. The solar stress factor value is based on the flux of UVA (320-400 nm) and/or UVB (290-320 nm) solar radiation (actinic flux). Here, the SSF is represented by the equation:

SSF=(J_{c}−Jₘᵢₙ)/(Jₘₐₓ−Jₘᵢₙ)

Referring to the above equation, J_{c} is the actinic flux at the location of the particular crop, Jₘᵢₙ is the minimum actinic flux where no solar stress occurs, and Jₘₐₓ is the maximum actinic flux that is predicted to damage plant tissues. As J_{c} approaches Jₘᵢₙ, the SSF approaches 0 (minimal stress); as J_{c} approaches Jₘₐₓ, the SSF approaches 1 (maximum stress). The solar stress factor may be used in addition to, or in substitution of, a CWSI value. Further, the methods for calculating the current plant tissue stress values discussed herein are not meant to be limiting. Additional and/or alternative methods, stress factors, indices and/or scales may be used as appropriate.

At step 110, data for calculating current plant tissue stress value is obtained. According to various exemplary embodiments, the data to be obtained depends on the method selected at step 105. The data may be obtained via one or more plant tissue sensors. The data may include soil moisture data, transpiration data, irrigation data and/or solar flux data. For example, sap-flow measurements based on the heat balance principle may provide a direct measurement of transpiration and may be monitored remotely. Other methods may provide similar data, including measurements of stomatal conductance, stem water potential, etc. Other types of data (especially data pertaining to water loss through plant tissues) may be obtained and fall within the scope of the various embodiments described herein.

In yet a further embodiment, the current plant tissue stress data may be obtained by weather sensors. Such data may include air temperature data, ground temperature data, humidity data, solar radiation data, and/or wind speed and direction data. Other types of data may be obtained and fall within the scope of the various embodiments described herein.

Limiting factors for obtaining some of the data include the cost and difficulty of implementing a system to measure actual crop transpiration (i.e., ETa). Weather data is often available through local weather, news, and/or agricultural media and broadcasting networks that may provide growers with weather data to estimate ETa without having to purchase and maintain sophisticated monitoring equipment. Additionally, ETo may be provided for a particular geographic region by local weather, news, and/or agricultural media and broadcasting networks.

At step 115, a current plant tissue stress value is calculated. In one exemplary embodiment, the Crop Water Stress Index method may be used to calculate a current plant tissue stress value. The calculated current plant tissue stress value is indicative of a current plant tissue stress value with respect to the particular crop. In some embodiments, a calculated current plant tissue stress value of one (1) indicates the particular crop is under full stress (i.e., no transpiration is occurring). In contrast, a calculated current plant tissue stress value of less than zero (0) indicates the particular crop is under no stress (i.e., maximum transpiration is occurring).

At step 120, an effective amount of a particle film may be applied to the plant tissues. According to various embodiments, if the calculated current plant tissue stress value is 0.2 or higher, an effective amount of a particle film may be applied to the particular crop. A particle film may be applied to all plant tissues, including fruits, stems, leaves and/or branches. In some embodiments, the particle film may be applied using a standard sprayer to spray a liquid suspension of the particle film onto the plant tissues. For instance, effective stress reduction may be attained by applying ten gallons of a ten percent (10%) aqueous calcium carbonate solution to one-hundred (100) square feet of planted seedlings. Five (5) to about ten (10) such applications per season may be required. The particle film solution may be applied to the seedlings one or more times before and/or after transplantation of the seedlings. Adding an application of the particle film to the soil surrounding the seedlings may result in additional plant tissue stress reduction. According to an alternative embodiment, the plant tissues may be irrigated in addition to or in substitution of the application of the particle film.

At step 125, a second (or post-application) current plant tissue stress value may be calculated. According to a further embodiment, a second current plant tissue stress value may be calculated at a subsequent point in time to indicate the effectiveness of the particle film and/or irrigation applied at step 120. The second current plant tissue stress value may also indicate whether a second particle film application and/or further irrigation are necessary.

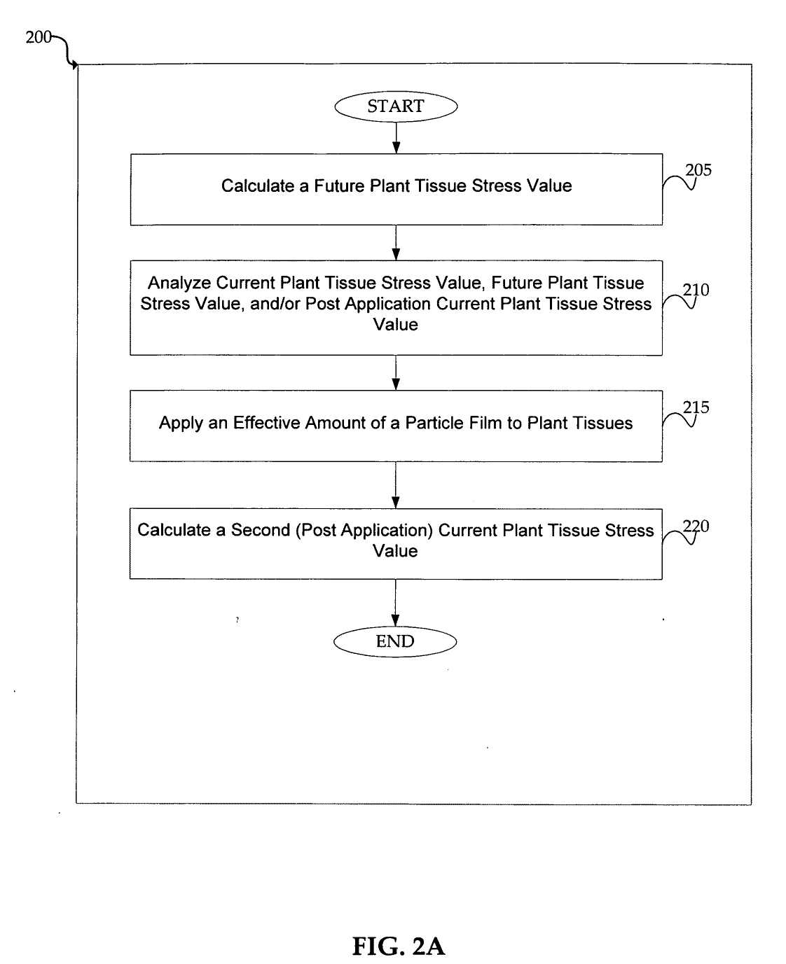

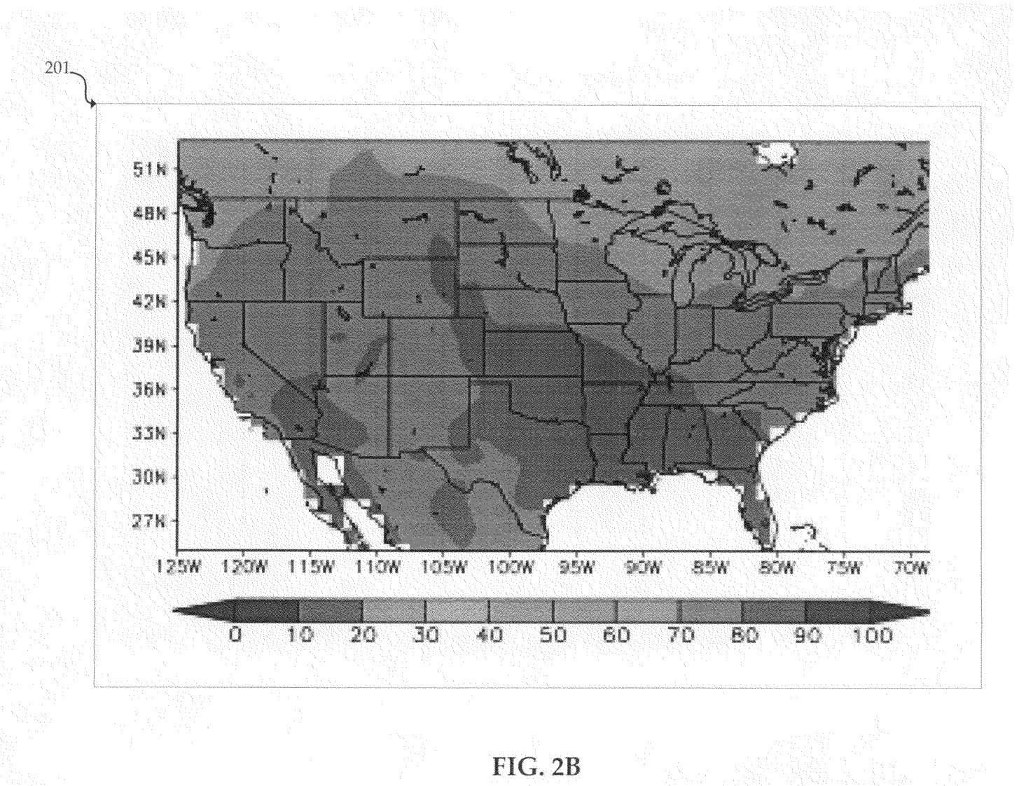

FIG. 2A is a flow chart of an exemplary predictive method 200 for controlling stress on plant tissues.

According to a further exemplary embodiment, one may predict and/or schedule when a particle film (and/or irrigation) will need to be applied to control stress on plant tissues. For instance, the Global Forecast System (GFS) may be used to obtain predictive data, such as ETa. The GFS is a global numerical weather prediction computer model operated by the National Oceanic and Atmospheric Administration (“NOAA”). The model is computed four times a day and produces forecasts up to sixteen days in advance, but with decreasing spatial and temporal resolution over time. The model is provided in two parts. The first part has a high resolution and extends up to 180 hours (7 days) in the future. The second part has a low resolution and extends up to 384 hours (16 days) in the future. The GFS model is available over the Internet. Using the Global Forecast System, ETa (measured) is replaced with ETa (predicted). Additionally, ETo may be replaced with a time-weighted average of historical data. Accordingly, future plant tissue stress values may be calculated over a particular time horizon.

At step 205, a future plant tissue stress value is calculated. Such calculations may use the methods discussed in step 105 (FIG. 1). For instance, PCSI may be calculated based on data from the GFS. Data from the GFS is available globally at a resolution of one (1.0) degree for both latitude and longitude. Forecasts are made every 6 hours at 00 Z, 06 Z, 12 Z and 18 Z (Z=coordinated universal or Greenwich Mean Time). UV data may be separately calculated by the Climate Prediction Center (CPC) using output from the GFS. UV forecasts are generally made at 12 Z for up to 120 hours. UV may depend on such factors as sun-earth distance, solar zenith angle, total ozone amount, tropospheric aerosol optical depth, elevation, snow/ice reflectivity, and/or cloud transmission.

FIG. 2B shows an exemplary PCSI UV forecast 201 for the United States. For air temperature and long-wave radiation, the forecasts are maximum values over the forecasted period. For UV, the forecasts are the accumulation of UV radiation over the immediately preceding thirty (30) day period. The combined index forecast is the weighted average of normalized maximum air temperature, maximum long-wave radiation and accumulated UV. Forecasts are given from 12 Z every day for up to 5 days into the future.

Referring again to FIG. 2A, according to a second embodiment, temperature distribution [i.e., T(r, θ)] may be calculated and used as a future plant tissue stress value. Temperature distribution may be calculated based on the intensity of radiation, thermal conductivity and heat loss. The intensity of illumination is a function of the reflectivity of a plant tissue surface, and may be modified by the application of a particle film. Reflectivity may be measured directly. An alternative method of reflectivity measurement may require only a measurement or estimation of particle film coverage currently in place. If no particle film has been applied, a database or estimation of reflectivity based on the particular crop may be used. The calculation may utilize a spectral average, multipoint spectrum or single wavelength. Thermal conductivity for specific crops may be measured or approximated. Heat loss is convective and may be computed based on actual or forecasted wind speed. A forecasted maximum temperature profile over a particular time horizon may be calculated, each point representing a future plant tissue stress value. For instance, if the forecasted maximum temperature profile exceeds a crop specific value [e.g., a core temperature of thirty to thirty-two degrees Celsius (30-32° C.) for apples], the application of a particle film would be recommended based upon the calculation.

At step 210, a control algorithm or statistical method is used to analyze the future plant tissue stress value (calculated at step 205) in light of a current plant tissue stress value [calculated at step 115 (FIG. 1)]. This analysis may also take into account a second (post-application) current plant tissue stress value calculation, including those performed at step 125 (FIG. 1) or step 220 (described herein).

The analysis performed at this step may provide a schedule of recommended application dates and/or application rates for applying a particle film (and/or irrigation) to a particular crop. For example, such an analysis may indicate at least one particle film application before transplantation and at least one particle film application after transplantation. This data may be logged and stored for future analysis or to provide historical data for use by the control algorithm or statistical method.

In some embodiments, CWSI threshold values may be determined for particular crops. For instance, Granny Smith apples grown in the Yakima Valley of Washington State are typically well-irrigated in the early growing season, and do not exhibit transpiration stress. Thus, Granny Smith apples may have a CWSI value of less than zero (0). In contrast, dry, hot, sunny days in the Yakima Valley may cause the Granny Smith apples to have a CWSI value of above two-tenths (0.2). A future plant tissue stress value represented by a CWSI value of at least 0.2 may warrant the application of a particle film and/or irrigation to the Granny Smith apples to reduce transpiration stress.

At step 215, an effective amount of a particle film may be applied to the plant tissues. For example, the particle film Purshade™ (a trademark of Purfresh, Inc.) may be applied to the Granny Smith apples to reduce the transpiration stress. Purshade™ is a calcium carbonate and boron colloidal liquid that has been proven effective in the control of sunburn on produce. Purshade™ may be sprayed directly on plant tissues to build a protective coating that blocks harmful UV light, without decreasing photosynthesis. The effective amount of the particle film may be a mixture of approximately two to five gallons of the particle film in approximately twenty to fifty gallons of water, and applied to the plant tissues found in an area of approximately one-square acre. Using Purshade™, growers have observed higher pack-outs, larger produce, better color and earlier harvest dates. Purshade™ may be sprayed at the same time with most other chemicals, saving time. The solution quickly mixes in a tank with minimal agitation, and with its small particle size, Purshade™ stays in suspension during spraying to give a uniform coat of protection. With food-grade calcium carbonate structure, Purshade™ may be applied throughout a growing season.

At step 220, a second (post-application) current plant tissue stress value may be calculated. According to a further embodiment, a second current plant tissue stress value may be calculated at a subsequent point in time to indicate the effectiveness of the particle film and/or irrigation applied at step 215. The second current plant tissue stress value may also indicate whether a second particle film application and/or further irrigation are necessary.

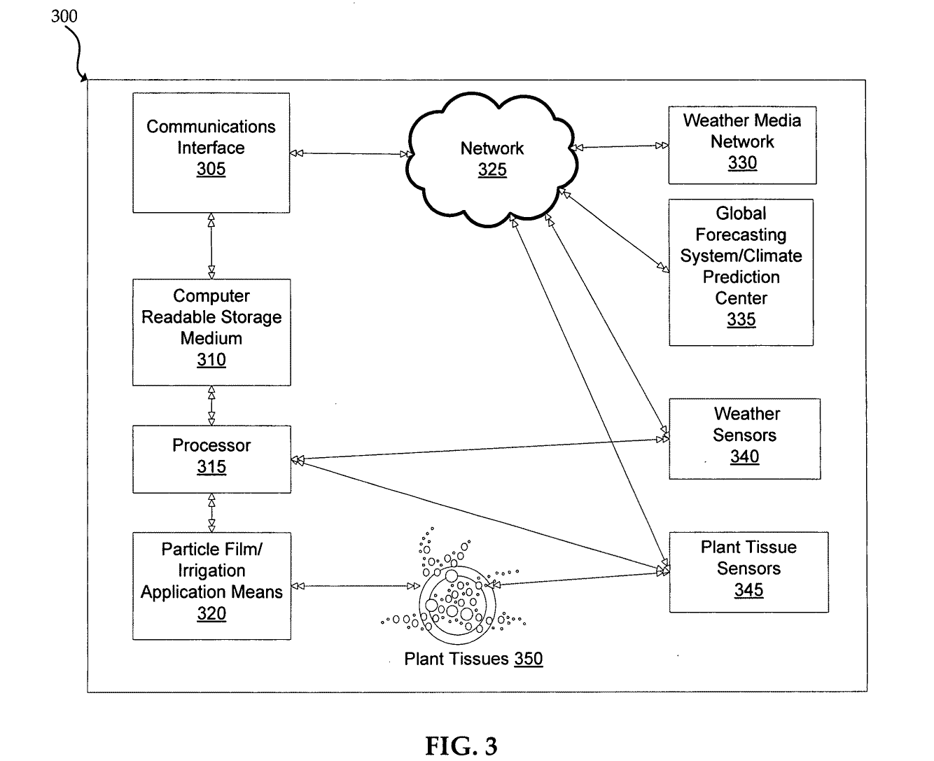

FIG. 3 shows an exemplary system 300 for applying particle films to control stress on plant tissues. The exemplary system 300 includes a communications interface 305, a computer readable storage medium 310, a processor 315, a particle film/irrigation application means 320, a network 325, a weather media network 330, a global forecasting system/climate prediction center 335, weather sensors 340, plant tissue sensors 345, and plant tissues 350.

According to various exemplary embodiments, the system 300 may include the communications interface 305 in electronic communication with the computer readable storage medium 310, the processor 315, and the particle film/irrigation application means 320. The computer readable storage medium 310 may further comprise instructions for execution by the processor 315. The instructions may cause the processor 315 to apply the particle film (or irrigation) to the plant tissues 350 via the particle film/irrigation means 320.

In one exemplary embodiment, the weather media network 330, the global forecasting system/climate prediction center 335, the weather sensors 340 and/or the plant tissue sensors 345 provide data via the network 325 to the communications interface 305. The data may be received and stored on the computer readable storage medium 310. Based on the received data and instructions stored in the computer readable storage medium 310, the processor 315 calculates a current plant tissue stress value for the plant tissues 350. If the calculated current plant tissue stress value is greater than or equal to a predetermined plant tissue stress value, the processor 315 may signal the particle film/irrigation application means 320 to apply an effective amount of a particle film (and/or water) to the plant tissues 350. The processor may execute other instructions as described herein and remain within the scope of contemplated embodiments. According to an alternative embodiment, the weather media network 330, the global forecasting system/climate prediction center 335, the weather sensors 340 and/or the plant tissue sensors 345 may provide data directly to the processor 315.

Another embodiment may include a computer readable storage medium 310 having a computer readable code for operating the processor 315 to perform a method for controlling stress on plant tissues 350, the method comprising calculating a current plant tissue stress value for the plant tissues 350, and applying an effective amount of a particle film to the plant tissues 350 if the calculated current plant tissue stress value is greater than or equal to a predetermined plant tissue stress value. The method may include other steps as described herein and remain within the scope of contemplated embodiments.

Examples of computer readable storage medium 310 include optical discs, memory cards, and/or computer discs. Instructions may be retrieved and executed by a processor, such as exemplary processor 315. Some examples of instructions include software, program code, and firmware. Instructions are generally operational when executed by the processor 315 to direct the processor 315 to operate in accord with embodiments of the invention. Some examples of computer readable storage medium 310 include memory devices, tape, and disks. Although various modules may be configured to perform some or all of the various steps described herein, fewer or more modules may be provided and still fall within the scope of various embodiments.

While various embodiments have been described herein, it should be understood that they have been presented by way of example only, and not limitation. Thus, the breadth and scope of a preferred embodiment should not be limited by any of the above-described exemplary embodiments.

What is claimed is:

1. A method for controlling stress on plant tissues, the method comprising:
selecting a method for calculating a current plant tissue stress value;
calculating the current plant tissue stress value for the plant tissues; and
applying an effective amount of a particle film to the plant tissues if the calculated current plant tissue stress value is greater than or equal to a predetermined plant tissue stress value.

2. The method of claim 1, the method further comprising:
calculating a second current plant tissue stress value for the plant tissues after the application of the effective amount of the particle film.

3. The method of claim 2, the method further comprising:
calculating a future plant tissue stress value for the plant tissues.

4. The method of claim 3, the method further comprising:
analyzing the calculated current plant tissue stress value, the second current plant tissue stress value, and the future plant tissue stress value to predict an application of the effective amount of the particle film to the plant tissues.

5. The method of claim 1, the method further comprising:
irrigating the plant tissues if the calculated current plant tissue stress value is greater than or equal to the predetermined plant tissue stress value.

6. The method of claim 5, the method further comprising:
irrigating the plant tissues until a calculated second current plant tissue stress value is less than or equal to the predetermined plant tissue stress value.

7. The method of claim 1, wherein the particle film includes calcium carbonate particles having an average size of less than one micron formulated in an aqueous suspension.

8. The method of claim 1, wherein the effective amount of the particle film is a mixture of approximately two to five gallons of the particle film in approximately twenty to one-hundred gallons of water.

9. The method of claim 8, wherein the effective amount is applied to the plant tissues found in an area of approximately one-square acre.

10. The method of claim 1, wherein the predetermined plant tissue stress value is 0.2.

11. The method of claim 1, wherein a crop water stress index is the selected method for calculating the current plant tissue stress value.

12. The method of claim 1, wherein a Purfresh™ crop stress index is the selected method for calculating the current plant tissue stress value.

13. The method of claim 1, wherein a solar stress factor is the selected method for calculating the current plant tissue stress value.

14. The method of claim 3, wherein the future plant tissue stress value is based at least in part on data from a global forecast system.

15. A system for applying particle films to control stress on plant tissues, the system comprising:
a processor;
a computer readable storage medium having instructions for execution by the processor which causes the processor to apply the particle film to control stress on the plant tissues;
wherein the processor is connected to the computer readable storage medium, the processor executing the instructions on the computer readable storage medium to:
calculate a current plant tissue stress value for the plant tissues; and
apply an effective amount of a particle film to the plant tissues if the calculated current plant tissue stress value is greater than or equal to a predetermined plant tissue stress value.

16. The system of claim 15, the system further comprising:
the processor executing the instructions on the computer readable storage medium to:
irrigate the plant tissues if the calculated current plant tissue stress value is greater than or equal to the predetermined plant tissue stress value.

17. The system of claim 16, the system further comprising:
the processor executing the instructions on the computer readable storage medium to:
irrigate the plant tissues until a calculated second current plant tissue stress value is less than or equal to the predetermined plant tissue stress value.

18. The system of claim 17, the system further comprising:
the processor executing the instructions on the computer readable storage medium to:
calculate a future plant tissue stress value for the plant tissues.

19. The system of claim 18, the system further comprising:
the processor executing the instructions on the computer readable storage medium to:
analyze the calculated current plant tissue stress value, the second current plant tissue stress value, and the future plant tissue stress value to predict an application of the effective amount of the particle film to the plant tissues.

20. A computer readable storage medium having a computer readable code for operating a computer to perform a method for controlling stress on plant tissues, the method comprising:
calculating a current plant tissue stress value for the plant tissues; and
applying an effective amount of a particle film to the plant tissues if the calculated current plant tissue stress value is greater than or equal to a predetermined plant tissue stress value.
